(19) United States
(12) Patent Application Publication
(10) Pub. No.: US 2015/0379549 A1
(43) Pub. Date: Dec. 31, 2015

(54) SYSTEMS AND METHODS FOR ELECTRONIC INK COUPONS AND LOYALTY CARDS

(71) Applicant: EBAY INC., San Jose, CA (US)

(72) Inventor: Michael Hwang, Sunnyvale, CA (US)

(21) Appl. No.: 14/319,026

(22) Filed: Jun. 30, 2014

(51) Int. Cl. G06Q 30/02

(52) U.S. Cl. CPC G06Q 30/0226; G06Q 30/0267

(57) ABSTRACT

Systems and methods are provided for electronic ink coupon and rewards card displays. An electronic ink device having an electronic ink display may be provided in the form of a keychain, a card, or other wearable device that is adapted to display store coupon and/or rewards card information for scanning at checkout. Coupons and store loyalty or rewards cards can be loaded onto a user's mobile device and pushed to the electronic ink device either before shopping at a particular store or while at the particular store. Coupons or rewards cards may be selectable with the electronic ink device and/or may be pushed to the electronic ink device in response to beacon communications at the store that notifies the user's mobile device or the electronic ink device of the store at which the device is located.

### TECHNICAL FIELD

The present invention generally relates to electronic commerce and, more particularly, to systems and methods for providing electronic ink coupons and rewards cards.

### BACKGROUND

Merchants often offer customers incentives to shop at that merchant. The incentives are often provided as paper or electronic coupons issued by the store or by a product manufacturer that makes products sold at a store. The incentives also sometimes include a rewards card associated with a particular store or store chain. For example, grocery stores often issue a rewards or loyalty card or a plastic keychain card with a bar code that is specific to a particular customer. When the customer pays for items at the grocery store, the customer hands a cashier the card to be scanned so that the customer receives discounts or rewards through an account associated with the card. However, it can be unwieldy for consumers to carry a separate card for each merchant at which they shop.

Some merchants also accept electronic coupons that can be accessed and presented through a bar code on a user's phone. However, the user typically must access the phone, access an account either on the phone or online, and choose the coupon to be scanned. However, this process can be time consuming in comparison with presenting a keychain card that is readily accessible and can offset the benefits of the electronic coupon for a typical customer.

It would therefore be desirable to be able to provide improved systems and methods for providing discounts and rewards devices for consumers.

### BRIEF DESCRIPTION OF THE DRAWINGS

FIG. 1 is a block diagram of an illustrative networked system suitable for implementing processes for providing discounts and rewards to consumers, according to an embodiment.

FIG. 2 is a diagram of an illustrative electronic ink device implemented as a keychain device, according to an embodiment.

FIG. 3 is a block diagram of an illustrative electronic ink device showing how a point of sale scanner at a merchant may scan a code displayed by the electronic ink device, according to an embodiment.

FIG. 4 is a diagram showing how communications between a user device and an electronic ink device may be used to provide information to the electronic ink device, according to an embodiment.

FIG. 5 is a block diagram showing how a camera in a user device may be used to input a coupon and a rewards card into a user device to be provided by the user device to an electronic ink device, according to an embodiment.

FIG. 6 is a block diagram showing how a user may select coupons and/or rewards cards to form a store group of coupons and/or rewards cards for a particular store that can be displayed on an electronic ink device when the user is at that particular store, according to an embodiment.

FIG. 7 is a block diagram showing how a coupon and/or rewards card for a particular store can be automatically displayed on an electronic ink device when the user is at that particular store, according to an embodiment.

FIG. 8 shows diagrams of an illustrative merchant location having a beacon and a point of sale device during check-in of a user device, during communications between a user device and an electronic ink device, and during a checkout operation using the electronic ink device, according to an embodiment.

FIG. 9 shows diagrams of an illustrative merchant location having a beacon and a point of sale device during check-in of an electronic ink device and during a checkout operation using the electronic ink device, according to an embodiment.

FIG. 10 is a block diagram of an illustrative mobile phone having an electronic ink display, according to an embodiment.

FIG. 11 is a block diagram of an illustrative electronic ink device implemented as a card, according to an embodiment.

FIG. 12 is a block diagram of an illustrative wearable electronic ink device implemented as a watch having an electronic ink display, according to an embodiment.

FIG. 13 is a block diagram of an illustrative networked system showing how multiple user devices may push coupons and/or rewards cards to a common electronic ink device, according to an embodiment.

FIG. 14 is a flowchart of an exemplary process for providing discounts and rewards to a consumer using an electronic ink device, according to an embodiment.

FIG. 15 is a flowchart of an exemplary process for displaying coupons and/or rewards cards with an electronic ink device, according to an embodiment.

FIG. 16 is a flowchart of another exemplary process for displaying coupons and/or rewards cards with an electronic ink device, according to an embodiment.

FIG. 17 is a flowchart of an exemplary process for displaying coupons and/or rewards cards with an electronic ink device based on beacon communications with a mobile device, according to an embodiment.

FIG. 18 is a flowchart of an exemplary process for displaying coupons and/or rewards cards with an electronic ink device based on beacon communications with the electronic ink device, according to an embodiment.

FIG. 19 is a block diagram of a computer system suitable for implementing one or more components of FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations provide equipment for communications with a user device of a user at the location. The equipment may include wireless communications equipment such as short range wireless communications equipment or other wireless communications equipment. The equipment may sometimes be referred to as beacon equipment or beacons. Wireless communications equipment that may be included in a beacon at a location may include Bluetooth Low Energy (BLE) beacon communications equipment, LTE Direct communications equipment, wireless local area network equipment (e.g., WiFi based equipment), cellular network equipment, global positioning system (GPS) equipment, combined cellular and GPS equipment, other radio or microwave based communications equipment, infrared communications equipment, and/or any combination thereof.

The beacons may communicate with the user device to provide the user device with location information. For example, when a user carriers their mobile device and/or an electronic ink device into a location such as a merchant location, a beacon located at or near an entrance to the location may communicate with the mobile device and/or the electronic ink device to receive identifying information of the user and/or to inform the mobile device and/or the electronic ink device which merchant the user has entered.

Based on the location information received from the beacon, the electronic ink device may be used to display one or more coupons and/or rewards cards associated with the merchant. The beacon communications can be received by the user's mobile device and the mobile device can push the coupons and/or rewards cards to the electronic ink device to be displayed or the beacon communications and/or the coupons and/or rewards cards can be provided directly to the electronic ink device. However, this is merely illustrative. In some embodiments, a user may manually select one or more coupons and/or rewards cards for the display using, for example, a touchscreen display or other input device of the electronic ink device.

An electronic ink device may be a keychain, a card, portion of a mobile phone or tablet, a wearable device such as a watch, glasses, ring, necklace, glove, nametag, shirt, or other electronic device having an electronic ink display. Providing an electronic ink display for presentations of coupons and/or rewards cards may help provide a more efficient shopping experience for consumers since the low power drawn by an electronic ink display can allow a coupon and/or a rewards card to remain on the electronic ink display throughout the user's shopping trip without overly draining a power supply for the device. In this way, an electronic coupon and/or rewards card can be provided for a consumer that is readily available at the time of checkout without the user accessing their mobile device, logging into an account, or launching an application, all of which can be undesirably time consuming. In this way, relatively low risk financial instruments such as loyalty cards and/or coupons that do not provide any access to user funding sources may be stored in a way that is more easily accessible than, for example, actual funding instruments that can be used for purchase (e.g., stored on an electronic ink device that does not necessarily required security information such as a password or other identifier to be accessed).

Beacons may provide communication services to a user device directly, including information stored on the beacons, and/or information from a device or server corresponding to the beacon. A service provider may include one or more locations such as merchant locations where the service provider offers products, services, or other items to users. Items, as used herein, may include physical goods, digital goods, services, donations, and anything that the user is making a payment for, to, or regarding. The service location(s) may utilize short range wireless beacons to communicate with mobile user devices of the users.

The short range wireless beacons may employ, for example, BLE communications that emit a signal receivable by a user device. The communication may include an identifier for the beacon. A user device or electronic ink device may passively monitor for beacon communications such as BLE communications. When, for, example, a user device detects a beacon signal such as a BLE signal and verifies the identifier as belonging to a particular location such as a merchant location, both the user device and the beacon may ramp up in power and establish a connection. The connection may further enable the user device to communicate with a service provider device and/or server. The beacon may be connected to a networked device at the service location, or the beacon may include network functionality to communicate with the service provider server.

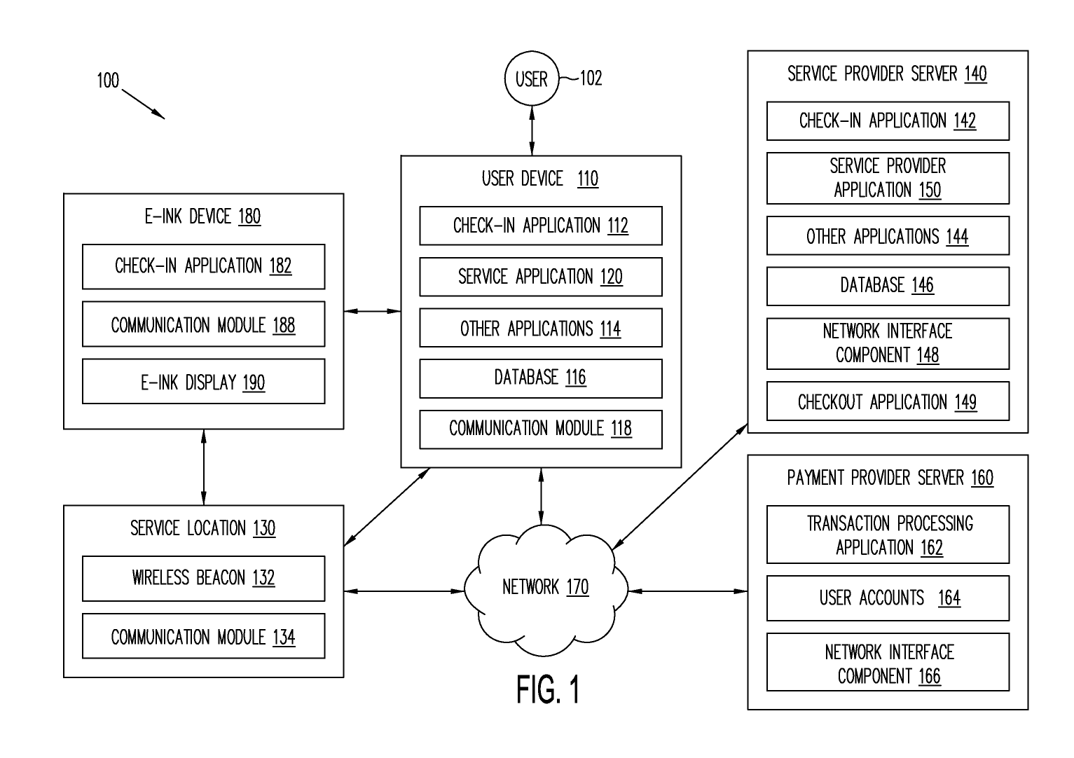

FIG. 1 is a block diagram of a networked system 100 suitable for implementing processes for providing discounts and/or rewards for consumers, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 may include one or more users such as user 102, each having a user device 110 and/or an electronic (e.g., electrophoretic) ink device 180. System 100 may also include a service location 130, a service provider server 140, and a payment provider server 160 in communication over a network 170. Each user 102 (e.g., a visitor to a service location such as a shopper at a merchant location), may utilize their corresponding user device 110 to check-in to service provider server 140. Service location 130 may correspond to a merchant location such as a store, a hotel, a restaurant, an entertainment location such as an arena, a stadium, a theater, an amusement park or any other location that offers goods and/or services for sale or otherwise accepts payments for goods, services, and/or donations. Service provider server 140 may correspond to a general server for multiple service locations (e.g. a server for a merchant chain) or may be specific to only service location 130 (e.g. a server for a particular merchant).

Check-in of users 102 may be accomplished through a beacon 132 (e.g., a wireless beacon) at service location 130, through a social media application or website or by other check-in equipment.

User device 110, electronic ink device 180, service location 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software such as hardware and software configured for wired and/or wireless communication with beacon 132, electronic ink device 180, and service provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. The user device may be managed or controlled by any suitable processing device.

As shown in FIG. 1, user device 110 may contain a check-in application 112, a service application 120, other applications 114, a database 116, and a communication module 118. Check-in application 112, service application 120, and other applications 114 may correspond to processes, procedures, and/or applications executable by a hardware processor, for example, a software program. In other embodiments, user device 110 may include additional or different software as required.

Check-in application 112 may be used by the user 102 of user device 110 to establish a connection between user device 110 and service provider server 140. Check-in application 112 may correspond to a specific application utilized by user device 110 with service provider server 140 to complete a check-in with service provider server 140. The check-in with service provider server 140 may correspond to a process to log in to a user account of user 102 with service provider server 140. In other embodiments, the check-in may provide and/or verify an identity of user 102, including transmission of an identifier for user 102 and/or user device 110. The check-in may be completed over network 170 with service provider server 140. In such embodiments, check-in application 112 may correspond more generally to a browser application configured to communicate with service provider server 140.

Check-in application 112 may also correspond to an application available over the Internet for download from service provider server 140 and/or other server corresponding to service location 130. Check-in application 112 may utilize communications module 118 to exchange short range wireless communications with beacon 132 at service location 130 to complete a check-in process. For example, service location 130 may include infrastructure with beacon 132 to communicate with user device 110 and complete the check-in process with service provider server 140. Beacon 132 may be configured to transmit an identifier for reception by user device 110.

Check-in application 112 may execute in the background of an operating system of user device 110 and be configured to establish connections, using communication module 118 of that user device 110, with one or more beacons 132 (e.g., wireless beacons) at service location 130. The connection may be established with or without user input from user 102. For example, beacon 132 may broadcast a token, such as a universally unique identifier (UUID), for reception by check-in application 112. Check-in application 112 may utilize communication module 118 of the user device 110 to receive the token from beacon 132. If check-in application 112 acknowledges the UUID as identifying service location 130, beacon 132, and/or service provider server 140, check-in application 112 may transmit an identifier corresponding to a user 102 and/or a user device 110 back to beacon 132. Check-in application 112 may utilize communication module 118 to communicate with beacon 132 (e.g., over near field communication, Bluetooth, Bluetooth Low Energy, radio, infrared, WiFi, cellular, GPS, combined cellular and GPS, microwave, a combination thereof, or other connection), The identifier from user device 110 may include, be transmitted with, concatenated with, or otherwise bundled with the identifier received from beacon 132.

Once a connection is established with beacon 132, user device 110 may be checked-in with service provider server 140 if the user 102 of that device is not currently checked-in. The check-in process may then associate that user 102 with the beacon 132 used to check-in that user 102 and/or other wireless beacons at the service location. In such embodiments, check-in application 112 of user device 110 may utilize short range wireless communication with beacon 132, such as near field communication, Bluetooth, Bluetooth Low Energy, radio, infrared, WiFi, cellular, GPS, combined cellular and GPS, microwave, a combination thereof, or other connection. Where beacon 132 corresponds generally to service location 130 or a location in or around service location 130, user 102 may be associated with service location 130 or a particular location in or around service location 130. Thus, user 102 may be associated with the location of that beacon and/or other nearby beacons.

Check-in application 112 may receive information from service provider server 140 and/or one or more payment provider servers 160. For example, check-in application 112 may receive merchant information such as a merchant identifier and/or a merchant location, maps, processes to request assistance from the service provider, etc. The information that is passed to check-in application 112 may be generally based on service location 130, such as an identifier of the service location or merchant, and/or products and/or services that are offered for sale at service location 130 or other information about and/or associated with service location 130. Additionally, the service provider server 140 and/or the payment provider server 160 may determine a user history, purchase history, user preferences, and/or other user information corresponding to user 102 from a user identifier transmitted to service provider server 140 during the check-in process. Thus, the information may be transmitted to user 102 based on the user history and/or the other user information. When a user 102 is checked-in with service provider server 140 and/or payment provider server 160, service provider server 140 and/or payment provider 160 may have an identifier of user device 110 and transmit the information to user device 110 using that identifier over network 170 and/or through one or more beacons 132.

Check-in application 112 may utilize communication module 118 to pass user information to service provider server 140 and/or payment provider 160, including user preferences, user calendar information, user relationship information, user email information, user social media information, user group membership information, user family information, user team information, identifiers of user 102 and/or user device 110, a request for assistance, a request for a type of assistance, product preference information, service preference information, etc.

Service application 120 may be used, for example, to provide a convenient interface to permit user 102 to receive, request, and/or view information, products and/or services. Service application 120 may correspond to an application specific to service location 130 and/or service provider server 140, such as an application downloadable over network 170 and/or through beacon 132. However, in other embodiments, service application 120 may correspond more generally to any application configured to receive information, targeted assistance, status updates, incentive offers, product offers, and/or service offers, including a browser application.

In various embodiments, check-in application 112 and service application 120 may be incorporated in the same application so as to provide their respective features in one convenient application interface.

User device 110 may include other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, mobile wallet, payment method selection, and/or other applications. Other applications 114 may include browser and/or mapping applications where the functions are not provided by check-in application 112 and/or service application 120. Other applications 114 may contain software programs, executable by a processor, including a graphical user interface (GUI) configured to provide an interface to the user.

User device 110 may further include memory such as database 116 which may include, for example, identifiers such as operating system registry entries, cookies associated with check-in application 112, service application 120, and/or other applications 114, identifiers associated with hardware of user device 110, or other appropriate identifiers, such as identifiers used for payment/user/device authentication or identification. Database 116 may include user device tokens and/or encryption keys, including a public key of service location 130 and/or service provider server 140 for beacon 132. Database 116 may include identifying information for tokens enabling check-in application 112 to identify beacon 132 when receiving a corresponding token. In one embodiment, identifiers in database 116 may be used to associate user device 110 with a particular account maintained by the account provider. Database 116 may further include online account access information and/or shopping list information.

User device 110 may include a communication module 118 adapted to communicate with beacon 132, service provider server 140, and/or payment provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, WiFi, cellular, GPS, combined cellular and GPS, microwave, near field communication devices, and/or a combination thereof. Communication module 118 may communicate directly with beacon 132 without network 170 using short range wireless communications.

Beacon 132 may check-in user 102 when the user device 110 and/or the electronic ink device 180 of that user is in proximity to beacon 132. Thus, beacon 132 may enable service provider server 140 and/or payment provider server 160 to associate a particular user 102 with service location 130 and/or a location within service location 130. Service location 130 may include a beacon 132 and a communication module 134. In other embodiments, service location 130 may include additional or different software and devices as required.

Beacon 132 may be maintained, for example, by service location 130 and service provider server 140 and/or one or more of payment provider servers 160. Beacon 132 may be implemented using any appropriate hardware and software configured for wireless communication with user device 110. For example, in one embodiment, beacon 132 may be implemented as a dongle device including a hardware processor and a communication module, for example, connected to device at service location 130. Thus, beacon 132 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Beacon 132 may also act as a stand-alone device including a processor, communication module, and/or network interface component configured to communicate with user device 110 and/or service provider server 140, such as another smart phone communicating through LTE Direct. Although a single beacon is described, a plurality of beacons may be utilized and be location specific within service location 130, as previous discussed.

Beacon 132 of FIG. 1 may include processes, procedures, and/or applications executable by a hardware processor, for example, a software program, configured to interact with user devices 110. Beacon 132 may include applications for transmitting requests to establish a connection between a user device and beacon 132. Thus, beacon 132 may utilize a low energy short range wireless communication of beacon 132 to transmit requests to establish a connection with user device 110 and/or electronic ink device 180, including an identifier such as a Universally Unique Identifier (UUID). If user device 110 and/or electronic ink device 180 receive a request to establish the connection with beacon 132 and respond with a device identifier (potentially including the UUID and other information to effectuate a check-in of each device), beacon 132 may ramp up in power and create a connection between user device 110 and/or electronic ink device 180 and beacon 132.

Beacon 132 may transmit the request to establish the connection with beacon 132 as a short range communication (e.g. a BLE protocol communication) including a “wake up” process for check-in applications 112 of user device 110 (and/or electronic ink device 180) and/or a token for beacon 132 or service provider server 140. In other embodiments, the request and/or connection may utilize near field communication, radio communication, infrared communication, or Bluetooth communication, BLE communication, WiFi communication, cellular communication, GPS communication, microwave communication, and/or any suitable combination thereof. The request may be specific to each device by including information that is specific to the corresponding user 102, such as a name, identifier, or user device identifier. The information specific to user 102 may be determined from user accounts of user 102 or other information previously provided to service provider server 140. Thus, in certain embodiments, only one or more specific user devices 110 and/or electronic ink devices 180 will pick up and authenticate the request.

After beacon 132 receives a device identifier of user 102, beacon 132 may determine that user 102 is at or in proximity to service location 130. Beacon 132 may pass the user device identifier to service provider server 140 and/or one or more of payment provider servers 160 to complete the check-in process and associate user 102 with service location 130. As shown in FIG. 1, beacon 132 utilizes communication module 134 to pass the information to service provider server 140 and/or one or more of payment provider servers 160. However, in other embodiments, beacon 132 may utilize a network connection of beacon 132 through a communication module of beacon 132. Additionally, beacon 132 may keep a communication channel open between user device 110 and/or electronic ink device 180 and service provider server 140 and/or one or more of payment provider servers 160 for passing information to and from the device.

In various embodiments, electronic ink device 180 includes an electronic (e.g., electrophoretic) ink display 190 adapted to display one or more coupons and/or rewards cards associated with service location 130. Electronic ink display 190 may be a touch sensitive display for receiving user input and displaying information or may be a non-touch sensitive display.

Electronic ink device 180 may also include a check-in application 182 and communication module 188 for performing check-in operations and/or other communications similar to those described herein in connection with check-in application 112 and communication module 118 of user device 110. Communication module 188 may provide electronic ink device 180 with near field communication capabilities, radio communication capabilities, infrared communication capabilities, or Bluetooth communication capabilities, BLE communication capabilities, WiFi communication capabilities, cellular communication capabilities, GPS communication capabilities, microwave communication capabilities, and/or any suitable combination thereof.

When a user enters a service location such as service location 130, one or more of user device 110 and electronic ink device 180 may communicate with beacon 132 as described herein. However, this is merely illustrative. In some embodiments, electronic ink device 180 may be provided without beacon communications capabilities and may receive information about service location 130 and/or instructions for displaying coupons and/or rewards card information from user device 110 (e.g., via near field and/or other wireless communications between user device 110 and electronic ink device 180).

In various embodiments, service location 130 includes at least one communication module 134 adapted to communicate with user devices 110, service provider server 140, and/or one or more of payment provider servers 160.

Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and GPS, microwave, near field communication devices, and/or any combination thereof. Communication module 134 may communicate directly with user device 110 without network 170 using short range wireless communications.

Service provider server 140 may be maintained, for example, by a service location including one or a plurality of service locations. Generally, service provider server 140 may be maintained by anyone or any entity that establishes and/or maintains a location with services and/or products offered to users. In this regard, service provider server 140 may include one or more applications, which may be configured to interact with user devices 110 and/or service location 130 to complete check-in processes for user devices 110. Although only one service provider server is shown, a plurality of service provider servers may be utilized. In various embodiments, the check-in and assistance features of service provider server 140 may also be offered by one or more of payment provider servers 160. Thus, all or part of the described features and processes of service provider server 140 may be incorporated within one or more of payment provider servers 160.

Service provider server 140 may include a check-in application 142, a service provider application 150, a database 146, and a network interface component 148. Check-in application 142 and service provider application 150 may correspond to processes, procedures, and/or applications executable by a hardware processor, for example, a software program. In other embodiments, service provider server 140 may include additional or different software as required.

Check-in application 142 may correspond to processes to complete check-in with user device 110. Thus, check-in application 142 may correspond to the server side application of service provider server 140 configured to transmit and/or receive check-in requests from user device 110 and complete the check-in requests. A check-in request may include log-in information for a user account in database 146. Check-in may be completed by verifying the account information. However, in embodiments where a user account has not been previously established by user 102, check-in application 142 may receive other information for identifying user 102, such as user names/identifiers, user device identifiers, group identifiers, an identifier for an account with another server (e.g., a payment account/payment account identifier with payment provider server 160), or other information.

Additionally, check-in application 142 may check user 102 out of the location when user 102 leaves the proximity of beacon 132. Checking user 102 out of a location may include checking the user out of the location corresponding to a particular beacon 132.

Service provider server 140 may include service provider application 150 configured to receive information corresponding to user 102 (e.g., a user identifier and/or other user information) that is checked-in to beacon 132 through service location 130 and provide information such as a merchant identifier, a merchant location, and/or product offers and/or service offers to user device 110 and/or electronic ink device 180.

Check-in information may correspond to one or more user accounts of user 102 with another server, such as one or more of payment provider servers 160. In such embodiments, service provider server 140 may determine user information such as a user history and/or user preferences from information received from a payment provider server 160. Payment provider server(s) 160 may provide information about previous purchases/visits by user 102 at the same or similar locations to service location 130 or may provide other information.

In various embodiments, service provider server 140 may include other applications 144 as may be desired in particular embodiments to provide features to service provider server 140. For example, other applications 144 may include security applications for implementing server-side security features, programmatic server applications for interfacing with appropriate application programming interfaces (APIs) over network 170, or other types of applications. Other applications 144 may contain software programs, executable by a processor, including a graphical user interface (GUI), configured to provide an interface to a user.

Service provider server 140 may include a database 146 which may include, for example, identifiers such as operating system registry entries, cookies associated with check-in application 142 and/or service provider application 150, identifiers associated with hardware of service provider server 140, or other appropriate identifiers, such as identifiers used for payment/user/device authentication or identification. Database 146 may include identifiers and/or user accounts of user 102, which may comprise an identifier for users 102, user device 110, and/or electronic ink device 180. In various embodiments, identifiers in database 146 may be used by a payment/credit provider, such as payment provider server 160, to associate user 102 with a particular account maintained by a payment provider server 160. For example, an identifier for a payment account with a payment provider server 160 may be stored with a user account and/or identifiers of users 102 in database 146. In other embodiments, a user account stored in database 146 may include a shared identifier with the payment account with a payment provider server 160.

In various embodiments, service provider server 140 includes at least one network interface component 148 adapted to communicate with user devices 110, service location 130, and/or payment provider servers 160 over network 170. In various embodiments, network interface component 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, BLE, cellular, GPS, combined cellular and GPS, microwave, near field communication devices, and/or any combination thereof.

Payment provider server 160 may include a payment provider server maintained, for example, by an online payment service provider, which may provide user account and payment services on behalf of user 102 and other users. In this regard, a payment provider server 160 includes one or more processing applications, which may provide payment for items using a user account with that payment provider server 160. In one example, payment provider server 160 may be provided by PAYPAL®, Inc. of San Jose, Calif., USA. Although payment provider server 160 is described as separate from service provider server 140, it is understood that payment provider server 160 may include services offered by service provider server 140 and vice versa.

Payment provider server 160 may include a transaction processing application 162, a database of user accounts 164, and a network interface component 166. Transaction processing application 162 may correspond to processes, procedures, and/or applications executable by a hardware processor, for example, a software program. In other embodiments, payment provider server 160 may include additional or different software as required.

Transaction processing application 162 may be configured to receive information from one or more user devices 110, electronic ink devices 180, and/or service provider server 140 for processing and completion of financial transactions. Transaction processing application 162 may include one or more applications to process financial transactions between user devices 110 and/or service provider server 140. Financial transactions may include financial information corresponding to user debit/credit card information, checking account information, a user account (e.g., payment account with a payment provider server 160), or other payment information. Transaction processing application 162 may complete the financial transaction for the purchase request by providing payment to service provider server 140. In various embodiments, transaction processing application 162 may provide transaction histories, including receipts, to user device 110 in order to provide proof of purchase for an item and/or service. Transaction processing application 162 may also provide the transaction histories to service location 130 for use in pick-up/delivery of the item and/or service.

Additionally, a payment provider server 160 includes user accounts 164. As previously discussed, user 102 may establish one or more user accounts with a payment provider server 160. User accounts 164 may include user information, such as name, address, birthdate, payment/funding information, travel information, additional user financial information, and/or other desired user data.

In various embodiments, each payment provider server 160 may include at least one network interface component 166 adapted to communicate with user device 110, service location 130, and/or service provider server 140 over network 170. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), infrared (IR), BLE, cellular, UPS, combined cellular and GPS, microwave, and/or near field communication devices, and/or any combination thereof.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

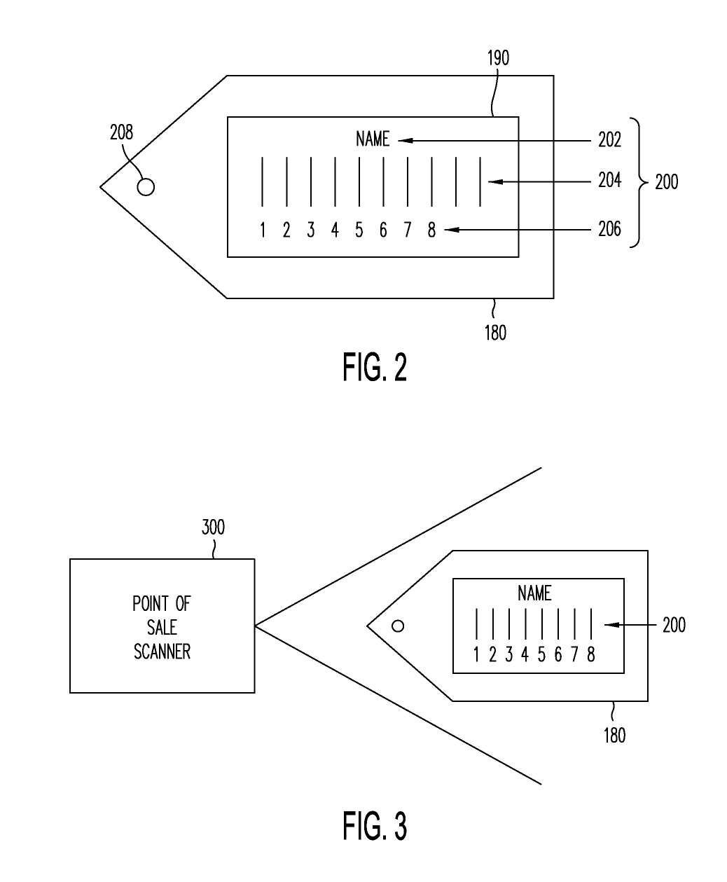

FIG. 2 is a diagram of an exemplary electronic ink device 180. As shown in FIG. 2, electronic ink device 180 may include an electronic ink display 190. Electronic ink display 190 may be operated by device 180 (e.g., one or more processors within device 180) to display an incentive 200 such as a coupon or a rewards or loyalty card. Incentive 200 may be associated with a particular merchant or store, with a particular product, and/or with user 102. Incentive 200 may include information such as a name 202 (e.g., the name of the store or product band or product identifier for which the incentive is provided), a scannable code such as bar code 204, and a numerical identifier 206 corresponding to the code. In the example of FIG. 2, device 180 is implemented in the form of an electronic keychain device having an opening 208 by which device 180 can be attached to a key ring of the user. However, this is merely illustrative and device 180 may be implemented in various other forms as desired.

When a user wishes to obtain a discount and/or reward associated with incentive 200, the user may provide device 180 to be scanned as shown in FIG. 3. For example, the user may hand device 180 to a clerk at a point of sale of a merchant to be scanned using a point of sale scanner 300 or the user may provide device 180 to scanner 300 themselves. Alternatively, the clerk or the user can manually type the numerical identifier 206 into a point of sale device.

When the information associated with incentive 200 is received by the merchant (e.g., at a merchant server via scanner 300), a discount, coupon value, and/or reward may be applied to the user's purchase from the merchant. Scannable code 204 may be a code that corresponds to a single coupon for a single product or merchant or may include information associated with multiple coupons, rewards cards, and/or other incentives of the user for a particular merchant so that a single scan of device 180 provides all of the user's coupons and/or rewards cards to the merchant.

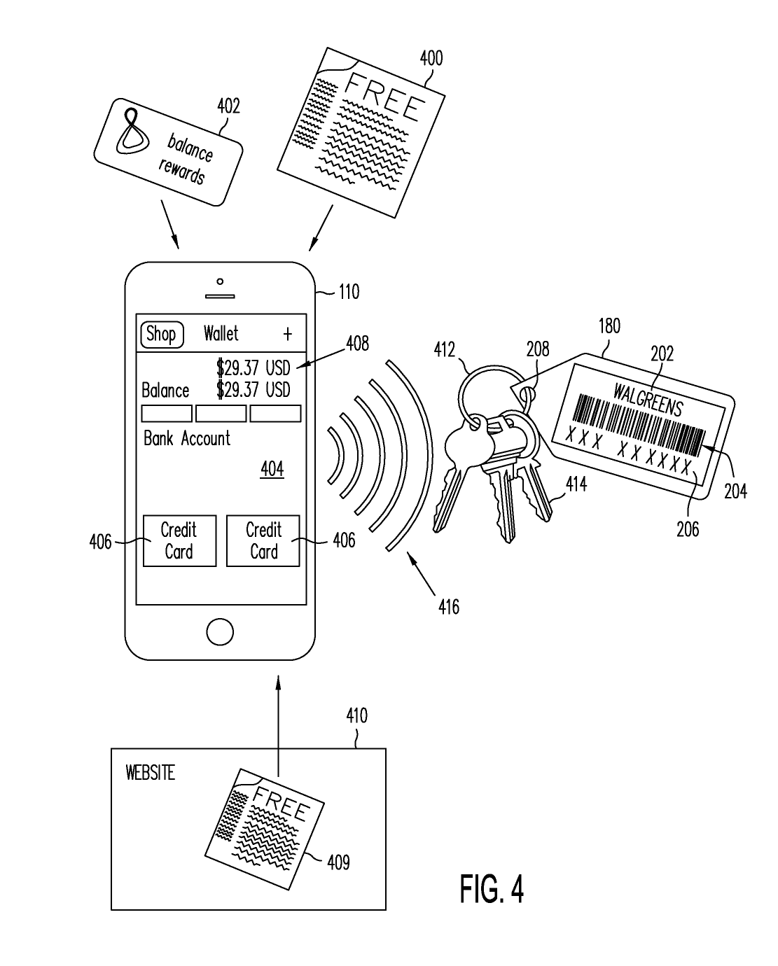

Incentive 200 may be provided to electronic ink device 180 from user device 110 as shown in FIG. 4. As shown in FIG. 4, a coupon 400 and a rewards card 402 for a merchant such as Walgreens® may be loaded onto user device 110 such as mobile phone of a user. Coupon 400 and rewards card 402 may be stored using, for example, a mobile wallet application 404 on the user device 110. Mobile wallet application 404 may also include one or more payment accounts 406 and an account balance 408 associated with, for example, an account of the user at a payment provider such as payment provider server 160 of FIG. 1.

Coupons and rewards cards may be provided directly to user device 110 or may be provided to user device 110 remotely such as via a website 410. As shown in FIG. 4, a coupon 409 may be selected and/or added using website 410 (e.g., a website associated with payment provider server 160) and provided to user device 110 via mobile wallet application 404 via a network such as the Internet. Once one or more coupons and/or rewards cards have been loaded onto user device 110, the coupons and or rewards cards may then be pushed to electronic ink device 180 via communications 416 such as near field communications. For example, a user may provide electronic ink device 180 in the vicinity of user device 110 having coupons and/or rewards cards. The user device 110 may detect the presence of electronic ink device 180 and provide the coupons and/or rewards cards and/or one or more names 202, scannable codes 204, and/or numerical identifiers 206 to electronic ink device 180.

As shown in FIG. 4, a key ring 412 having one or more keys 414 may pass through opening 208 so that electronic ink device 180 may be carried with a user's keys for use at various merchants. Communications 416 may be provided prior to shopping using electronic ink device 180 (e.g., when the coupons and/or rewards card are loaded onto user device 110) or during a shopping experience. For example, when user device 110 receives merchant information from a beacon at a merchant, the user device may push coupons and/or rewards cards for that merchant to electronic ink device 180 via communications 416 responsive to receiving the merchant information.

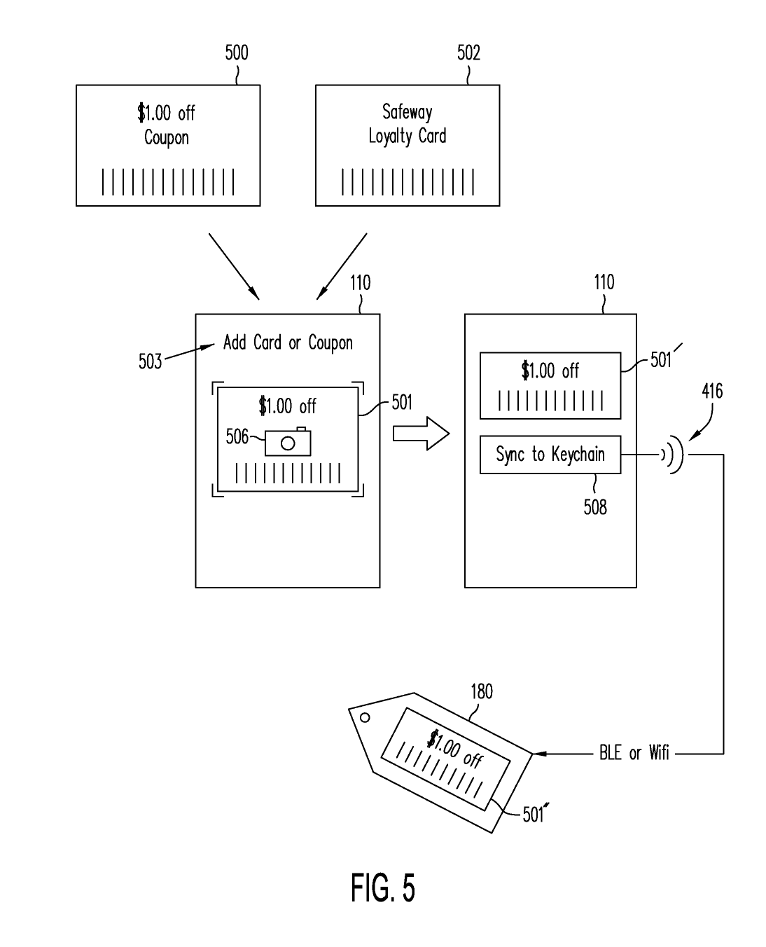

In one embodiment, coupons and/or rewards cards may be loaded onto user device 110 by, for example, capturing a picture using a camera of the user device as shown in FIG. 5. As shown in FIG. 5, a user may open an application 503 on the user device for loading merchant incentives such as coupons, rewards cards, or other incentives. Application 503 may be a dedicated application associated with an electronic ink device or may be part of another application such as a payment provider application or mobile wallet application.

In the example of FIG. 5, a “$1 off coupon” 500 and a “Safeway® Loyalty Card” 502 are to be loaded onto user device 110 using application 503 to add a card or coupon. As shown, a user may move the coupon 500 into the field of view of a camera of device 110 and an image 501 of coupon 500 may be displayed on a display of device 110. When the image 501 of coupon 500 is displayed, the user may capture the image (e.g., by tapping a camera icon 506 on the display or otherwise instructing the camera to capture the image). A captured image 501′ of coupon 500 may then be displayed along with a selectable or clickable option 508 such as a virtual button that, when selected (e.g., clicked, tapped, or otherwise selected) by the user, initiates communications 416 to transfer the coupon information for coupon 500 (e.g., via BLE, WiFi® or other communications protocol) to electronic ink device 180. When the coupon has been received by electronic ink device 180, an image 501″ of the coupon may be displayed using the electronic ink display of the electronic ink device.

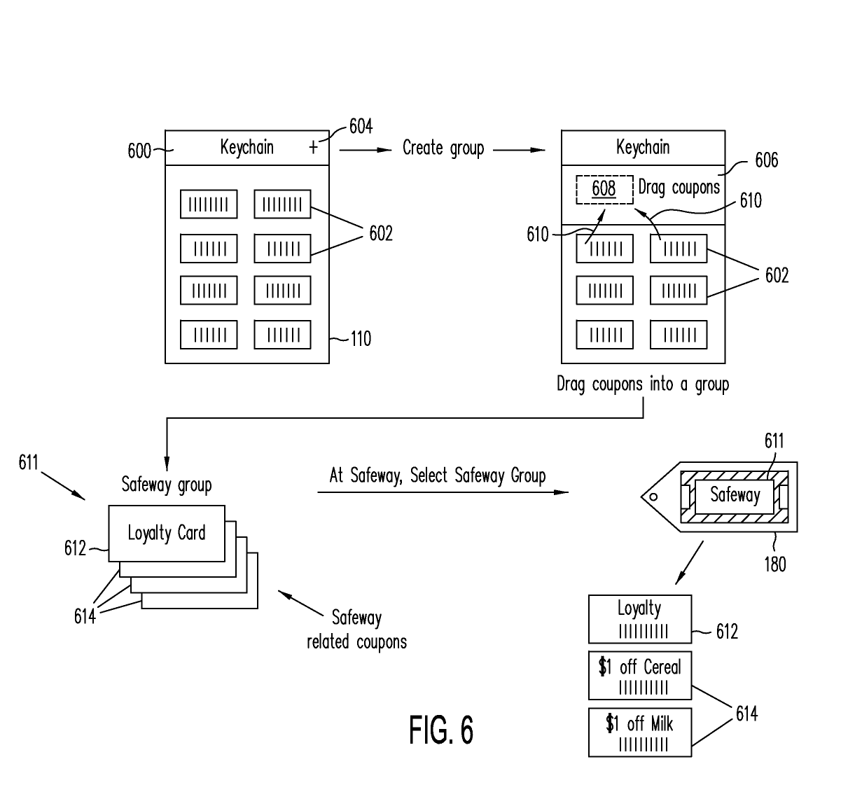

In some embodiments, a user may be provided with the ability to group coupons and/or cards. For example, various coupons and a rewards card for a particular merchant may be stored in a group that is easily obtained by the user when the user arrives at that merchant. FIG. 6 illustrates one example of a process for generating coupon and/or card groups. As shown in FIG. 6, in an electronic ink device application such as keychain application 600 running on user device 110, various incentives 602 that have been loaded onto user device 110 may be displayed. Application 600 may include a selectable icon 604 for initiating creation of a group of coupons and/or cards.

When selected, a “Drag coupons” section 606 of the application may be displayed having a virtual depository 608 into which incentives 602 may be dragged to form a group of incentives (as indicated by arrows 610). For example, a user may touch an incentive 602 and, using a touchscreen of device 110, slide a finger along the touchscreen from the incentive 602 to virtual depository 608 to deposit that incentive 602 into a group such as Safeway® group 611. The user may be provided with the ability to name the group or a group name may be automatically determined from the information stored in connection with the incentives that have been placed into the group.

As shown in FIG. 6, a group such as Safeway® group 611 may include a Safeway® Loyalty Card 612 and one or more Safeway® related coupons 614 (e.g., coupons issued by Safeway® and/or coupons for products offered for sale at Safeway® stores). Group 611 may then be pushed to electronic ink device 180.

At the Safeway® store, the Safeway® group 611 may be displayed on an electronic ink display of device 180. The user may be provided with the ability to select from the incentives in the group (e.g., by scrolling or clicking through the incentives that were pushed to device 180) or a scannable code may be provided that encodes and/or links to all of the incentives in the group.

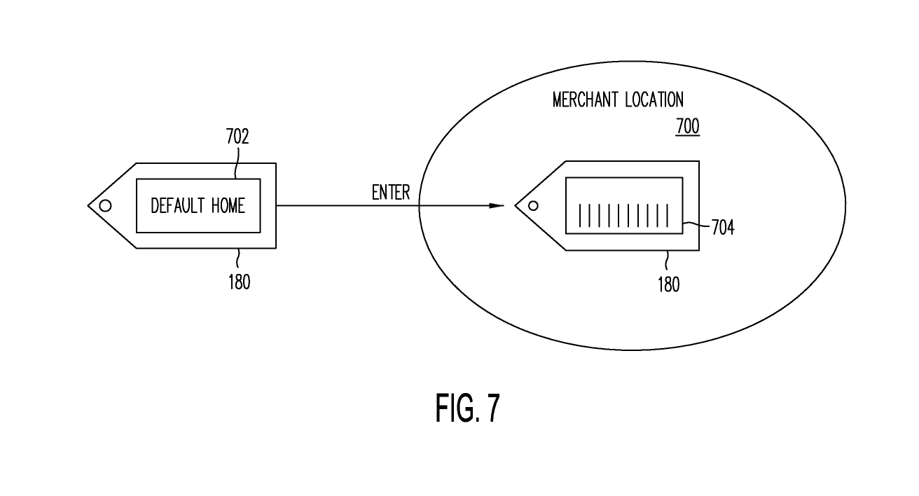

An incentive group such as incentive group 611 may be pushed to electronic ink device 180 when the user moves electronic ink device 180 into the vicinity of electronic device 110 or an incentive group 611 may be stored on user device 110 and pushed to electronic ink device 180 only when the user is at a location associated with that group. FIG. 7 illustrates an example of an electronic ink device 180 displaying a default home screen 702 that is carried into a merchant location 700 (e.g., a Safeway® store) and the display of the electronic ink device 180 is updated with an incentive 704 or group of incentives associated with that merchant location.

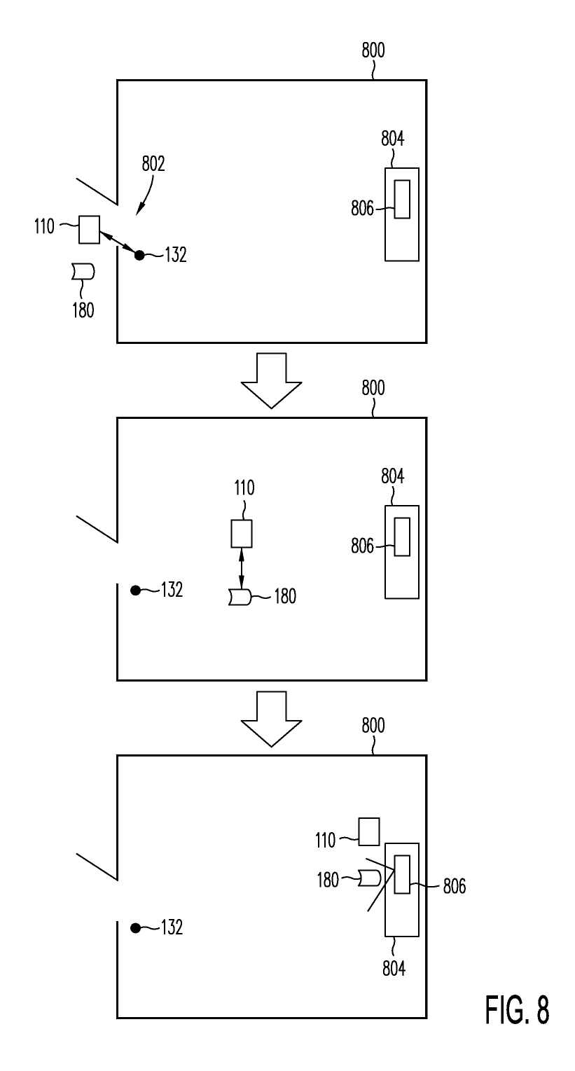

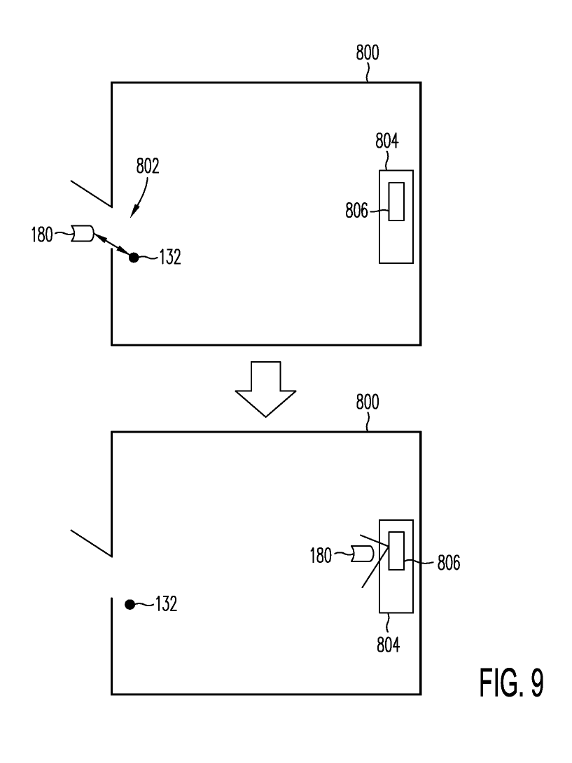

The display of the electronic ink device 180 may be updated based on communications with one or more beacons at the merchant location with the electronic ink device 180 and/or with a user device 110 associated with the electronic ink device 180. FIGS. 8 and 9 show how communications between a beacon at a location and a user device and an electronic ink device 180 respectively can be used to update the display of the electronic ink device 180.

As shown in FIG. 8, communications between a user device 110, a beacon 132, and an electronic ink device 180 can be exchanged at various times during a user's shopping experience at a merchant 800 to prepare the electronic ink device 180 for presenting coupons and/or rewards cards to the merchant at the time of checkout, according to an embodiment. As shown in the top diagram of FIG. 8, a merchant location 800 may include an entrance 802 at which one or more beacons such as beacon 132 are located. When a user carries a user device such as user device 110 through the entrance 802, user device 110 and beacon 132 may exchange information as, for example, described herein. For example, user device 110 may receive location information from beacon 132 using BLE communications (for example) when user device 110 is within the proximity (e.g., within 10 feet, within 10 meters, within 5 feet, within 100 feet, within 1 meter, or within 1 foot) of beacon 132. While user device 110 and beacon 132 are in communication, user device 110 may be checked into the merchant location 800.

While user device 110 is in communication with beacon 132, one or more updates to coupons and/or cards stored by user device 110 may be updated. For example, beacon 132 may communicate with a service provider server and/or a payment provider server to determine and obtain any updates, upgrades, or other incentives for the user.

As shown in the middle diagram of FIG. 8, after the user device 110 has received the location information and, if desired, any updates, from beacon 132, user device 110 may communicate with electronic ink device 180 (e.g., via BLE or other near field communication or other communication protocols) to push incentives (e.g., coupons and/or rewards cards or groups of coupons and/or rewards cards) to electronic ink device 180 or to instruct electronic ink device 180 to display incentives associated with the location.

Based on the communications between electronic ink device 180 and user device 110, electronic ink device 180 may display one or more incentives associated with the merchant location 180 on an electronic ink display of electronic ink device 180 so that, when the user is at or near a point of sale 804 of merchant location 800 (e.g., as in the bottom diagram of FIG. 8), a point of sale scanner 806 may be used to receive (e.g., scan) the displayed incentive. However, the processes and systems described above in connection with FIG. 8 are merely illustrative. In another embodiment, electronic ink device 180 may communicate directly a beacon such as beacon 132 at a merchant location.

FIG. 9 is a diagram showing how direct communications between a beacon 132 and an electronic ink device 180 can be exchanged at merchant 800 to prepare the electronic ink device 180 for presenting coupons and/or rewards cards to the merchant at the time of checkout, according to an embodiment. As shown in the top diagram of FIG. 9, when a user carries electronic ink device 180 through the entrance 802, electronic ink device 180 and beacon 132 may exchange information as, for example, described herein. For example, electronic ink device 180 may receive location information from beacon 132 using BLE communications (for example) when electronic ink device 180 is within the proximity (e.g., within 10 feet, within 10 meters, within 5 feet, within 100 feet, within 1 meter, or within 1 foot) of beacon 132.

While electronic ink device 180 is in communication with beacon 132, one or more updates to coupons and/or cards stored by electronic ink device 180 may be updated. For example, beacon 132 may communicate with a service provider server and/or a payment provider server to determine and obtain any updates, upgrades, or other incentives for the user.

As shown in the bottom diagram of FIG. 9, based on the communications between electronic ink device 180 and beacon 132, electronic ink device 180 may display one or more incentives associated with the merchant location 800 on an electronic ink display of electronic ink device 180 so that, when the user is at or near point of sale 804 of merchant location 800, point of sale scanner 806 may be used to receive (e.g., scan) the displayed incentive.

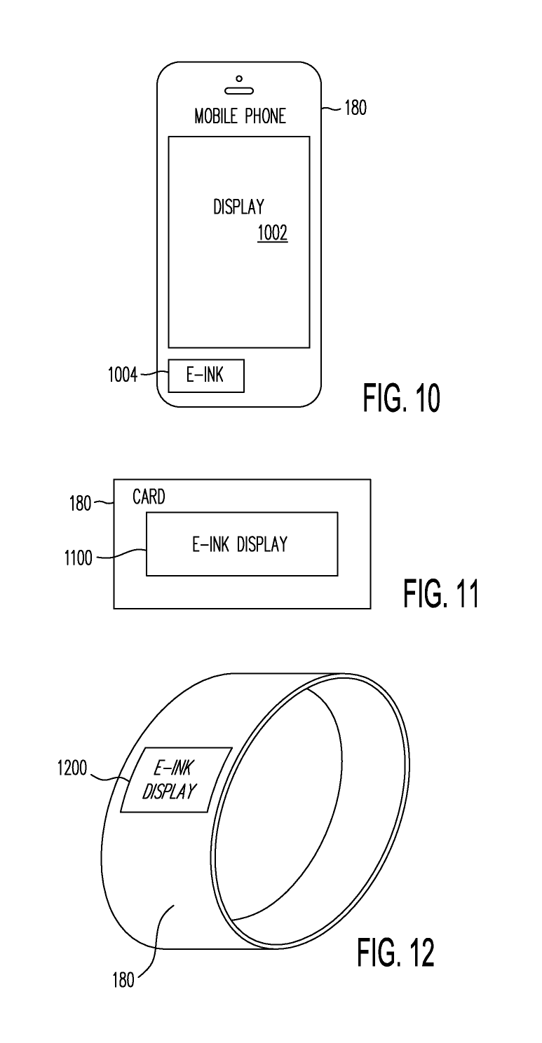

FIGS. 10, 11, and 12 show various implementations of electronic ink device 180. As shown in FIG. 10, electronic ink device 180 may include an electronic ink display 1004 that is integrated into a mobile phone. The mobile phone may include an additional display 1002 (e.g., a liquid crystal display or light emitting diode display) in addition to electronic ink display 1004. In this embodiment, the functions of user device 110 and electronic ink device 180 may be combined. For example, main display 1004 may be used in conjunction with a camera of the mobile phone to load coupons and/or cards onto the mobile phone that are then displayed using a low power electronic ink display 1004 when the user is at a merchant location.

In another embodiment, electronic ink device 180 may be implemented as a card having an electronic ink display 1100 as shown in FIG. 11. In this way, an electronic ink device may be provided that fits into a user's wallet, purse, money clip, or pocket along with other cards such as credit cards or debit cards.

In another embodiment, electronic ink device 180 may be implemented as a wearable electronic device having an electronic ink display such glasses, a ring, a necklace, a glove, a nametag, a shirt, or other wearable apparatus having an electronic ink display such as a watch having an electronic ink display 1100 as shown in FIG. 12.

In some embodiments, more than one user device may be used to provide incentives such as coupons and/or rewards (loyalty) cards to an electronic ink device 180. For example, while one member of a family is shopping at a merchant location with an electronic ink device 180, another member of the family or a friend can upload one or more coupons to an online account associated with electronic ink device 180 so that the uploaded coupon(s) are transferred to electronic ink device 180 (e.g., from a server or through a user device of the first family member).

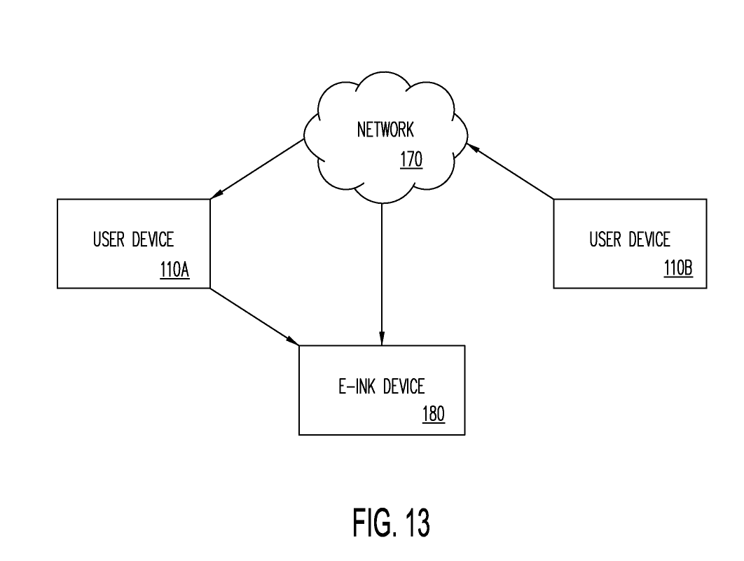

FIG. 13 shows an example of two user devices 110A and 110B that provide coupon and/or card information to electronic ink device 180. In one example scenario, coupon and/or card information may be loaded onto user device 110A and pushed to electronic ink device 180. Additional coupon and/or card information may also be loaded onto user device 110B. The additional coupon and/or card information can then be provided from user device 110B to user device 110A (e.g., via network 170) and subsequently pushed to electronic ink device 180 or the additional coupon and/or card information can be pushed to electronic ink device 180 (e.g., via network 170) without passing through user device 110A.

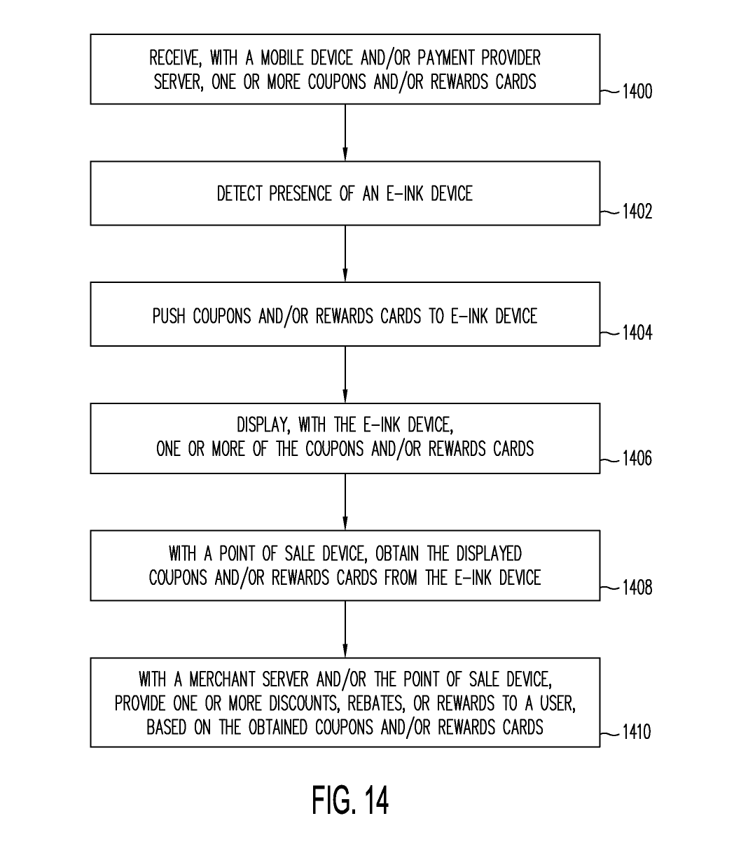

FIG. 14 is a flowchart of an exemplary process for providing electronic ink coupons and/or rewards cards, according to an embodiment.

At step 1400, a mobile device and/or a payment provider server may receive one or more coupons and/or rewards cards. The mobile device and/or the payment provider server may receive the coupons and/or rewards cards when a user of the mobile device loads the coupons and/or rewards cards on the mobile device. According to various embodiments, the coupons and/or rewards cards can be stored in one or more memories of the mobile or can be provided to one or more memories of the payment provider server from the mobile device for storage.

At step 1402, the presence of an electronic ink device may be detected. The presence of the electronic ink device may be detected by the mobile device (e.g., using BLE or other near field or WiFi® communications) and/or by a beacon at a merchant location.

At step 1404, the coupons and/or rewards cards may be pushed to the electronic ink device. The coupons and/or rewards cards may be pushed to the electronic ink device based on the detection of the presence of the electronic ink device. The coupons and/or rewards cards may be pushed to the electronic ink device from the mobile device and/or from a payment provider server or merchant server storing the coupons and/or rewards cards. The coupons and/or rewards cards that are pushed to the electronic ink device may be coupons and/or rewards cards associated with a particular merchant at which the electronic ink device is located, as determined by communications between a beacon such as a wireless beacon and the mobile device and/or the electronic ink device.

At step 1406, the electronic ink device may be used to display one or more coupons and/or rewards cards that have been received from the mobile device and/or a server. The displayed coupons and/or rewards cards may be coupons and/or rewards cards associated with a particular merchant at which the electronic ink device is located, as determined by communications between a beacon such as a wireless beacon and the mobile device and/or the electronic ink device.

At step 1408, the displayed coupons and/or rewards cards may be obtained with a point of sale device from the electronic ink (e-ink) device. Obtaining the displayed coupons and/or rewards cards may include scanning a code displayed on the electronic ink device with a point of sale scanner or receiving numerical input via a keypad or touchscreen display at the point of sale.

At step 1410, a merchant server and/or the point of sale device may provide one or more discounts, rebates, rewards and/or other incentives to a user based on the obtained coupons and/or rewards cards.

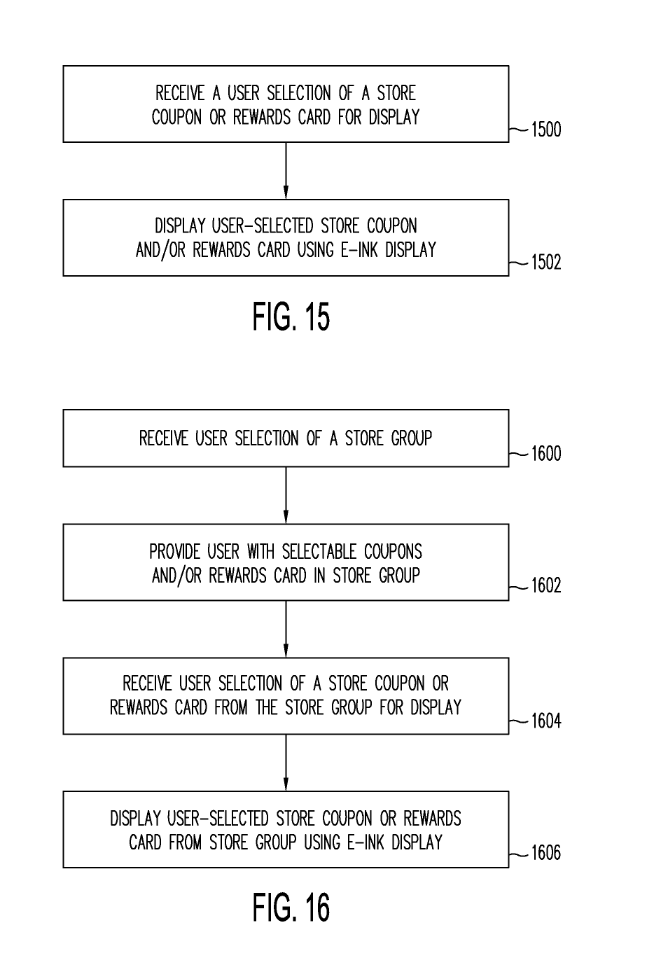

A more detailed example of operations that may be performed for displaying one or more coupons and/or rewards cards using an electronic ink device is shown in FIG. 15 according to one embodiment.

At step 1500, an electronic ink device may receive a user selection of a store coupon or rewards card for display. For example, a user may scroll or click through several available coupons and/or rewards cards stored on the electronic ink device and select a particular one of the available coupons and/or rewards cards.

At step 1502, an electronic (e.g., electrophoretic) ink display of the electronic ink device may be used to display the user-selected store coupon and/or rewards card (e.g., by displaying a scannable code such as a bar code associated with the store coupon and/or rewards card).

A more detailed example of operations that may be performed for displaying one or more coupons and/or rewards cards using an electronic ink device is shown in FIG. 16, according to another embodiment.

At step 1600, an electronic ink device may receive a user selection of a store group of store coupons or rewards cards for display. For example, a user may scroll or click through several available groups of coupons and/or rewards cards each associated with, for example, a particular store that are stored on the electronic ink device and select a particular one of the available groups.

At step 1602, the electronic ink device may provide the user with selectable coupons and/or rewards cards in the user-selected group.

At step 1604, the electronic ink device may receive a user selection of a store coupon or rewards card from the selected group for display

At step 1606, an electronic (e.g., electrophoretic) ink display of the electronic ink device may be used to display the user-selected store coupon and/or rewards card from the selected group (e.g., by displaying a scannable code such as a bar code associated with the store coupon and/or rewards card).

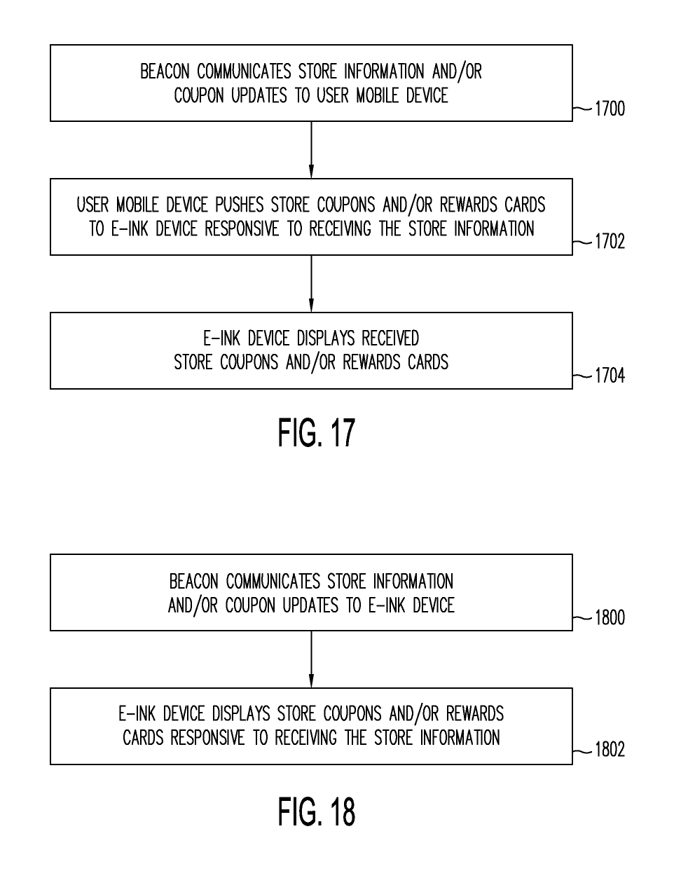

A more detailed example of operations that may be performed for displaying one or more coupons and/or rewards cards using an electronic ink device is shown in FIG. 17, according to another embodiment.

At step 1700, a beacon at a merchant location such as a store may communicate store information and/or coupon updates to a user mobile device. For example, the store information may be provided to the user mobile device when the mobile device is in proximity to and communication with the beacon (e.g., when the user enters the store).

At step 1702, the user mobile device may push store coupons and/or rewards cards to the electronic ink device responsive to receiving the store information. Pushing the store coupons and/or rewards cards to the electronic ink device responsive to receiving the store information may include, selecting from multiple stored coupons and/or rewards cards that are stored on the user mobile device, coupons and/or rewards cards associated with the store using the received store information and pushing those selected store coupons and/or rewards card to the electronic ink device.

At step 1704, an electronic (e.g., electrophoretic) ink display of the electronic ink device may be used to display the store coupons and/or rewards cards received from the user mobile device (e.g., by displaying a scannable code such as a bar code associated with a store coupon and/or rewards card).

A more detailed example of operations that may be performed for displaying one or more coupons and/or rewards cards using an electronic ink device is shown in FIG. 18, according to another embodiment.

At step 1800, a beacon at a merchant location such as a store may communicate store information and/or coupon updates to an electronic ink device. For example, the store information may be provided to the electronic ink device when the electronic ink device is in proximity to and communication with the beacon (e.g., when the user enters the store).

At step 1802, an electronic (e.g., electrophoretic) ink display of the electronic ink device may be used to display store coupons and/or rewards cards responsive to receiving the store information (e.g., by displaying a scannable code such as a bar code associated with the store coupon and/or rewards card). Displaying the store coupons and/or rewards cards responsive to receiving the store information may include, selecting from multiple stored coupons and/or rewards cards that are stored on the electronic ink device, coupons and/or rewards cards associated with the store using the received store information and displaying one or more of those selected store coupons and/or rewards card with the electronic ink display.

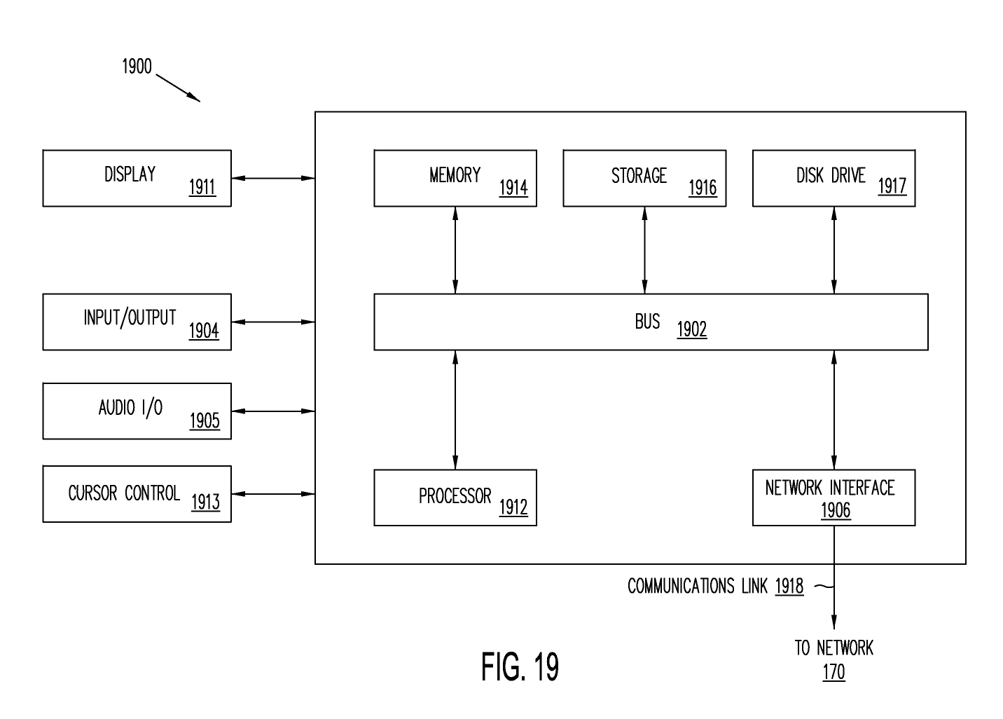

FIG. 19 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 1900 in a manner as follows.

Computer system 1900 includes a bus 1902 or other communication mechanism for communicating information data, signals, and information between various components of computer system 1900. Components include an input/output (I/O) component 1904 that processes a user action, such as selecting keys from a keypad/keyboard, selecting one or more buttons, image, or links, and/or moving one or more images, etc., and sends a corresponding signal to bus 1902. I/O component 1904 may also include an output component, such as a display 1911 and a cursor control 1913 (such as a keyboard, keypad, mouse, etc.). An optional audio input/output component 1905 may also be included to allow a user to use voice for inputting information by converting audio signals. Audio I/O component 1905 may allow the user to hear audio. A transceiver or network interface 1906 transmits and receives signals between computer system 1900 and other devices, such as another user device, a merchant device, or a service provider server via network 170. In one embodiment, the transmission is wireless, although other transmission mediums and methods may also be suitable. One or more processors 1912, which can be a micro-controller, digital signal processor (DSP), or other processing component, processes these various signals, such as for display on computer system 1900 or transmission to other devices via a communication link 1918. Processor(s) 1912 may also control transmission of information, such as cookies or IP addresses, to other devices.

Components of computer system 1900 also include a system memory component 1914 (e.g., RAM), a static storage component 1916 (e.g., ROM), and/or a disk drive 1917. Computer system 1900 performs specific operations by processor(s) 1912 and other components by executing one or more sequences of instructions contained in system memory component 1914. Logic may be encoded in a computer readable medium, which may refer to any medium that participates in providing instructions to processor(s) 1912 for execution. Such a medium may take many forms, including but not limited to, non-volatile media, volatile media, and transmission media. In various embodiments, non-volatile media includes optical or magnetic disks, volatile media includes dynamic memory, such as system memory component 1914, and transmission media includes coaxial cables, copper wire, and fiber optics, including wires that comprise bus 1902. In one embodiment, the logic is encoded in non-transitory computer readable medium. A non-transitory computer-readable medium may include instructions which, in response to execution by a computer system, cause the computer system to perform some or all of one or more methods as described herein. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1900. In various other embodiments of the present disclosure, a plurality of computer systems 1900 coupled by communication link 1918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an electronic ink device comprising:
an electronic ink display; and
one or more hardware processors in communication with the electronic ink display and configured to:
receive one or more coupons;
store the one or more coupons with one or more hardware memories; and
display, with the electronic ink display, a selected one of the one or more coupons.

2. The system of claim 1, further comprising a mobile device of a user, wherein the one or more hardware processors are configured to receive the one or more coupons from the mobile device of the user.

3. The system of claim 2, wherein the one or more hardware processors are configured to receive the one or more coupons from the mobile device of the user when the mobile device is at a merchant associated with the one or more coupons.

4. The system of claim 1, wherein the electronic ink device comprises a keychain having the electronic ink display.

5. The system of claim 1, wherein the electronic ink device comprises a wearable device having the electronic ink display.

6. The system of claim 1, wherein the wearable device comprises a watch.

7. The system of claim 1, wherein the one or more hardware processors are configured to receive the one or more coupons when a mobile device of the user is in proximity to a wireless beacon and in communication with the wireless beacon using one of near field communication, radio communication, infrared communication, Bluetooth communication, cellular communication, global positioning system communication, and Bluetooth low energy communication.

8. A method comprising:
receiving, with an electronic ink device of a user, one or more coupons;
storing, with the electronic ink device, the one or more coupons; and
displaying, with an electronic ink display of the electronic ink device, a selected one of the one or more coupons.

9. The method of claim 8, further comprising receiving a user selection of the selected one of the one or more coupons from the user.

10. The method of claim 9, further comprising providing, with the electronic ink display, the one or more coupons for selection by the user.

11. The method of claim 8, wherein the receiving comprises receiving the one or more coupons from a mobile device of the user.

12. The method of claim 11, further comprising receiving, with the mobile device, the one or more coupons.

13. The method of claim 12, wherein the receiving with the mobile device comprises capturing an image of each of the one or more coupons using a camera of the mobile device.

14. The method of claim 11, further comprising:
determining that the electronic ink device is within a proximity of the mobile device; and
providing the one or more coupons from mobile device to the electronic ink device based on the determining.

15. The method of claim 11, further comprising:
receiving, with the mobile device from a beacon at a merchant, store information; and
providing the one or more coupons to the electronic ink device responsive to the receiving of the store information.

16. The method of claim 8, further comprising:
receiving, with the electronic ink device from a beacon at a merchant, store information; and
wherein the displaying comprises displaying the selected one of the one or more coupons responsive to the receiving.

17. The method of claim 8, further comprising:
receiving, with a mobile device and from the user, an indication that at least some of the one or more coupons are a group of coupons; and
providing the group to the electronic ink device.

18. The method of claim 17, further comprising receiving, with the electronic ink device, a selection of the group of coupons from the user.

19. A non-transitory computer-readable medium comprising instructions which, in response to execution by a computer system, cause the computer system to perform a method comprising:
receiving one or more store coupons and/or store loyalty cards for a store from an external device;
storing the one or more store coupons and/or store loyalty cards; and
displaying, with an electronic ink display, a selected one of the one or more store coupons and/or store loyalty cards.

20. The non-transitory computer-readable medium of claim 19, wherein the receiving comprises receiving the one or more store coupons and/or store loyalty cards from the external device when the external device is in communication with a beacon at the store.
